(19) United States
(12) Patent Application Publication
(10) Pub. No.: US 2020/0293431 A1
(43) Pub. Date: Sep. 17, 2020

(54) TEST SYSTEM

(71) Applicant: Rohde & Schwarz GmbH & Co. KG, Munich (DE)

(72) Inventor: Andreas Dippon, Munich (DE)

(73) Assignee: Rohde & Schwarz GmbH & Co. KG, Munich (DE)

(21) Appl. No.: 16/352,599

(22) Filed: Mar. 13, 2019

(51) Int. Cl. G06F 11/36; G06F 8/34

(52) U.S. Cl. CPC G06F 11/3664; G06F 8/34

(57) ABSTRACT

A test system comprises a display and a processor. The processor is configured to generate a graphical user interface that is displayed on the display. The graphical user interface generated provides a visual programming editor. The visual programming editor comprises at least one of a first visual programming member and a second visual programming member. The processor is configured to provide a semantic zoom function for the graphical user interface. The semantic zoom function is configured to provide a semantic zooming of at least one of the first visual programming member and the second visual programming member such that a subgroup assigned to the respective visual programming member is displayed on the display via the graphical user interface.

### FIELD OF THE DISCLOSURE

Embodiments of the present disclosure relate generally to a test system.

### BACKGROUND

Test systems, also called measurement systems, are known in the state of the art in order to test a device under test with respect to a predefined test scenario. The test scenario may comprise several test sequences that are performed in a subsequent manner. Typically, these test sequences or rather the entire test scenario are/is defined by a user of the test system. For instance, the user has to interact with the test system in a continuous manner in order to define or rather start the different test sequences one after the other.

Furthermore, it is known to use visual block programming for creating a certain program by simply adding different blocks together. However, visual block programming typically provides a simple view that is not sufficient for complex programs that may comprise nested structures. Thus, the visual block programming used in the state of the art gets very uncomfortable with increasing complexity of the intended program.

In order to overcome these issues, it is known to store substructures or rather nested structures in a separate block in which the respective substructures or rather nested structures are grouped. Moreover, the grouped substructures may be folded in order to obtain a good overview in higher hierarchy levels. The respective blocks that contain the substructures may be edited by clicking on them wherein a pop-up window is generated that provides the content of the respective block containing the substructures. Alternatively, the folded groups have to be unfolded in order to be viewed and edited.

However, the techniques known in the state of the art do not provide a seamless interaction since a pop-up window or rather an unfolded group is displayed that has no connection to the overall structure, particularly the higher levels.

Accordingly, there is a need for a test system that provides a high functionality with regard to visual programming.

### SUMMARY

Embodiments of the present disclosure provide a test system that comprises a display and computing device, such as a processor, etc. In some embodiments, the processor is configured to generate a graphical user interface (GUI) that is displayed on the display. The graphical user interface generated provides a visual programming editor that comprises at least one of a first visual programming member and a second visual programming member. The processor is also configured to provide a semantic zoom function for the graphical user interface. The semantic zoom function is configured to provide a semantic zooming of at least one of the first visual programming member and the second visual programming member such that a subgroup assigned to the respective visual programming member is displayed on the display via the graphical user interface.

Accordingly, the semantic zooming provides a seamless interaction within one editor window displayed on the display such that established connections of subgroup members to the overall setup are still comprehensible for the user of the test system, as no pop-up window or separate window is generated for illustrating the members of the subgroup. The subgroup may generally comprise substructures or rather nested structures. Put another way, the substructures or rather nested structures are stored in a group assigned to the corresponding visual programming member. Each substructure or rather nested structure may relate to a visual programming sub-member that can be zoomed as well.

The user may edit or rather view the content of the respective visual programing member by zooming into the respective visual programming member. In some embodiments, the closer the user gets, the more content of the respective visual programming member is displayed on the display via the graphical user interface. In general, the respective semantic zoom function provides a zooming of a certain portion or rather region of the graphical user interface, namely the respective visual programming member that shall be zoomed. The other visual programming members may remain in their previous hierarchy level, namely in a non-zoomed condition. Put another way, different hierarchy levels may be displayed simultaneously within one window of the graphical user interface due to the semantic zoom function that is only applied to at least one visual programming member. Thus, a content exchange between different hierarchy levels can be ensured such that the user of the test system can easily move between an overview and intricate details by using the semantic zoom function. Further, substructures or rather nested structures can be moved between the different hierarchy levels easily, as these different hierarchy levels are displayed at the same time. In other words, the semantic zoom function relates to a mechanism to view an underlying meaning inside a certain visual programming member, namely the substructures or rather the nested structures. In contrast to ordinary graphical zoom, the semantic zoom does not only change parameters of a graphical representation, but also modifies the selection and structure of data to be displayed.

The visual programming editor generally uses a visual programming language (VPL) that lets a user of the test system create a program, particularly a test sequence or rather a test scenario, by manipulating program elements, namely the visual programming members, graphically via the graphical user interface rather than by specifying the program elements textually. Accordingly, a more intuitive programming is ensured by using a visual programming language, as the user does not need to be familiar with any textual programming language. In fact, the user simply interacts with the graphically displayed visual programming members.

The visual programming language may be based on boxes and arrows/lines, which are used as visual programming members. Hence, boxes are selected and connected with each other via arrows/lines that indicate a processing direction. In other words, an arrow may indicate that the output of a first box shall be forwarded to a second box that processes the outputted data in an appropriate manner. Alternatively, the boxes can be connected directly with each other.

For instance, the visual programming editor may be based on Blockly. The visual programming language may also use semantic programming members that provide some mechanisms to disclose the meaning of the respective programming members.

Generally, the visual programming editor provides an intuitive drag-and-drop interface such that the user of the test system is enabled to build individual test sequence(s)/test scenario(s) in a simple manner by simply interacting with the visual programming members provided. For instance, the user may interact with the graphical user interface, for example the visual programming editor, by selecting and moving the respective visual programming members to a certain position. The order of the visual programming members may relate to a temporal sequence of the respective visual programming members.

An aspect provides that the test system comprises a graphical zoom function. The graphical zoom function is configured to zoom the entire graphical user interface displayed on the display. Thus, the graphical zoom function distinguishes from the semantic zoom function, as the graphical zoom function simply zooms into the illustrated content, namely the entire graphical user interface. The graphical zoom changes parameters of the respective graphical representation. In contrast to the graphical zoom, the semantic zoom zooms only into the respective visual programming member selected. Therefore, the graphical zoom function and the semantic zoom function are two different zoom functions that, however, can be combined.

Another aspect provides that the test system comprises an input interface to select the respective visual programming member to be zoomed. Via the input interface, the user of the test system may select the at least one visual programming member that shall be displayed in more detail (zoomed manner) in order to obtain information with regard to the subgroup or rather content of the respective visual programming member(s).

For instance, the input interface is provided by the display. The display may be established as a touch-sensitive one, such as a touchscreen. Accordingly, the user may easily interact with the display of the test system in order to select the respective visual programming member that shall be zoomed.

Alternatively, the input interface may correspond to a rotary knob for selecting the respective visual programming member to be zoomed by turning the rotary knob. Via a push button or rather a push function of the rotary knob, the user may confirm its selection in order to initiate the semantic zoom. Other input interfaces, such as keyboards, touchpads, computer mice, etc., or combinations thereof, can be used.

Furthermore, at least one of the first visual programming member and the second visual programming member may be assigned to a test sequence. By interacting with the graphical user interface, the user may generate a certain test sequence by combining the respective visual programming members. Moreover, the user may generate a test scenario that comprises different test sequences by interacting with the visual programming members.

The first visual programming member and the second visual programming member both may be assigned to a test sequence. The test system is configured to generate a test scenario via the visual programming editor. The respective visual programming members may be connected with each other in a desired manner in order to generate the test scenario that comprises several test sequences.

Alternatively, the visual programming members are assigned to certain aspects of a single test sequence such that the visual programming members are assigned to the test sequence, namely the respective parameters used for the single test sequence.

Generally, the visual programming members may be assigned to blocks, which can be connected with each other in a desired manner in order to define a test scenario or rather a test sequence.

Accordingly, the user is enabled to generate a test scenario or rather a test sequence that shall be applied to a device under test that is connected with the test system.

Another aspect provides that the visual programming editor comprises a plurality of visual programming members that are configured to be combined with each other in order to generate a test scenario. For instance, the test scenario may comprise several test sequences that are performed one after another. Alternatively, the test scenario may comprise a single test sequence that has several parameters which are assigned to different visual programming members that are connected with each other.

The test system may comprise a testing module that is configured to perform a test on the device under test that is connected with the test system. The testing module may be controlled by the processor of the test system with respect to a test scenario or rather test sequence generated via the visual programming editor.

The plurality of visual programming members may be assigned to at least one of a test plan, a test sequence, a test function and a test command. In other words, the test plan, the test sequence, the test function and/or the test command may be assigned to a test scenario or rather a test sequence. The respective components of the test scenario or rather test sequence may be connected with each other while interacting with the visual programming editor, for example the graphical user interface that is configured to display the visual programming editor on the display of the test system.

The semantic zoom function may be assigned to at least one of a collapsing and expanding the respective visual programming member. Thus, the user is enabled to move through the hierarchy of the respective visual programming member. As already mentioned, the visual programming member may comprise several visual programming sub-members which may further comprise respective subgroups such that different hierarchy levels are provided.

Another aspect provides that semantic zoom function comprises at least one zoom level. Depending on the visual programming member, for example the assigned hierarchy, different zoom levels may be provided that ensure to illustrate all hierarchies of the respective visual programming member.

For instance, the semantic zoom function comprises at least one of a test plan zoom, a test sequence zoom, a test function zoom and a test command zoom. Depending on the respective zoom applied, only components of the subgroup assigned to the respective visual programming member may be displayed on the graphical user interface.

In other words, the respective zoom used may correspond to a filter.

Typically, each visual programming member is assigned to the test plan, the test sequence, the test function or the test command such that the respective semantic zoom is defined by the respective type of content assigned to the visual programming member.

At least one of the test plan zoom, the test sequence zoom, the test function zoom and the test command zoom may have at least one zoom level. The different zooms may also have different hierarchy levels that can be zoomed appropriately.

For instance, the zoom level assigned to the test command zoom corresponds to opening a source code editor that is displayed on the display. The user may edit the respective source code in order to adapt the test command.

The subgroup assigned to the respective visual programming member may correspond to a nested structure. Hence, sub-functions or rather parameter settings assigned to the respective visual programming member may be retrieved while using the semantic zoom function. The sub-functions or rather parameter settings retrieved can be edited in the zoomed-in condition, for instance.

Another aspect provides that the nested structure is only displayed on the display via the graphical user interface if the semantic zoom function for the respective visual programming member has been activated. Accordingly, a simple overview is given to the user of the test system. In the overview, the highest hierarchy level or rather a starting hierarchy level is displayed. However, the starting hierarchy level may be equal for all visual programming members displayed if no semantic zoom is applied.

Accordingly, substructures or rather nested structures are stored in a block or group that is assigned to the respective visual programming member. The user can interact with or rather use these visual programming members normally.

To edit/view the content of the respective visual programming member, the user can zoom into the visual programming member and the closer the user gets, the more content of the visual programming member is displayed. For instance, visual programming sub-members are displayed that are grouped in a certain visual programming member.

Each of the visual programming sub-members could have further nested structured or rather substructures that could also be zoomed into again for more details.

Accordingly, the user seamlessly interact in the same editor window of the graphical user interface, for example the visual programming editor, the connections to necessary context from other visual programming members, for instance Input/Output Variables, could still be displayed. The user can quickly move between overview and internal details. Accordingly, blocks assigned to visual programming members or rather visual programming sub-members can be moved easily between different hierarchy levels, for instance by dragging, namely drag into/out of nested block.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a test system according to an embodiment of the present disclosure;

FIG. 2 shows an overview of a semantic zoom function applied according to a an embodiment of the present disclosure; and

FIG. 3 shows an overview of a semantic zoom function applied according to another embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

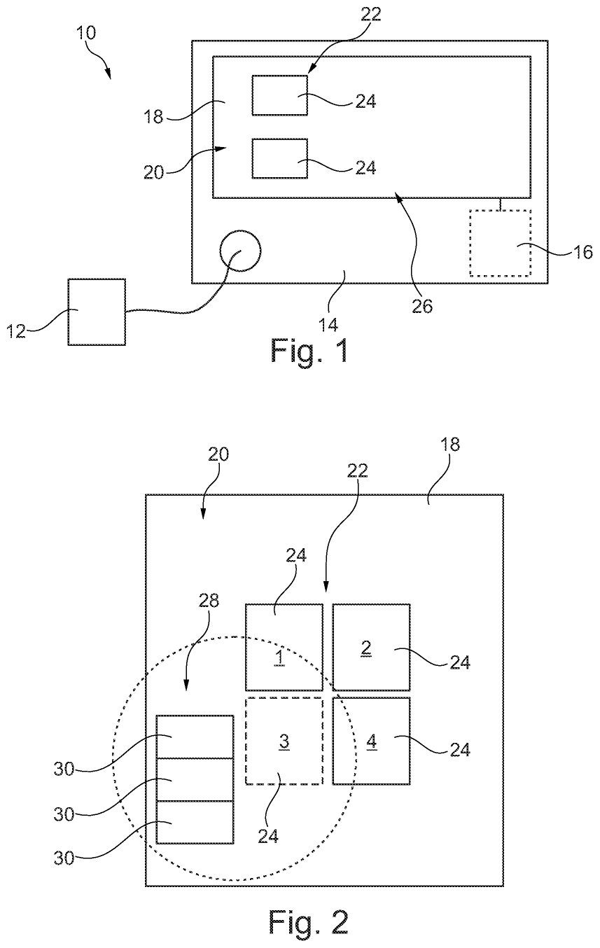

FIG. 1 schematically shows a test system 10 that is connected with a device under test 12. As shown in FIG. 1, the test system 10 has a housing 14 that encompass one or more computing devices, such as a processor 16. In an embodiment, the processor 16 is connected with a display 18 that is located at a side of the housing 14. For instance, the display 18 is located in a frame assigned to the housing 14. Alternatively, the processor 16 can be integrated within the display 18.

The one or more computing devices can include, for example, a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

The processor 16 is generally configured to generate a graphical user interface 20 that is displayed on the display 18. The graphical user interface 20 provides a visual programming editor 22 via which a user interacting with the test system 10 is enabled to generate a test scenario or rather a test sequence that can be used by the test system 10 for testing the device under test 12.

The visual programming editor 22 comprises several visual programming members 24 that are illustrated as blocks which can be connected with each other in order to generate the test scenario or rather the test sequence in a desired manner.

For interacting with the graphical user interface 20 or rather the visual programming editor 22, the test system 10 has an input interface 26 that is established by the display 18 itself in the shown embodiment. In some embodiments, the display 18 is a touch-sensitive one such that the user may interact with the test system 10 by touching the display 18. Alternatively, a knob, for instance a rotary knob, is provided that can be used by the user for interacting with the graphical user interface 20 or rather the visual programming editor 22. Other input interfaces, such as keyboards, touchpads, computer mice, etc., or combinations thereof, can be used.

In the shown embodiment of FIG. 2, the visual programming editor 22 comprises four visual programming members 24 indicated by the numbers “1” to “4” for distinguishing purposes. Typically, the visual programming members 24 are named differently.

In general, the processor 16 is configured to provide a semantic zoom function for the graphical user interface 20, wherein the semantic zoom function is applied on at least one of the visual programming members 24. The respective visual programming member 24 can be selected via the input interface 26, for instance by touching the display 18.

In the shown embodiment of FIG. 2, the semantic zoom function was activated for the third visual programming member 24 such that a subgroup 28 assigned to the respective visual programming member 24 is displayed via the graphical user interface 20 on the display 18.

The third visual programming member 24 selected is not shown anymore, as the respective subgroup 28 is displayed. Therefore, the third visual programming member 24 labelled with “3” is illustrated by dashed lines. However, the remaining visual programming members 24, namely the ones labelled with “1”, “2” and “4”, remain in their un-zoomed status as shown in FIG. 2.

As shown, the subgroup 28 comprises several visual programming sub-members 30 that relate to a lower hierarchy level with respect to the third visual programming member 24 labelled with “3” or rather all other visual programming members 24 labelled with “1”, “2” and “4”. Thus, a nested structure is provided.

In other words, different hierarchy levels are displayed simultaneously in a common window of the graphical user interface 20 or rather the visual programming editor 22.

Therefore, the blocks assigned to the visual programming members 24 and/or the visual programming sub-members 30 can be moved easily between different hierarchy levels by simply drag and moving them.

Accordingly, the respective semantic zoom function provides a zooming of a certain portion or rather region of the graphical user interface 20, namely the respective visual programming member(s) 24 that shall be zoomed. The other visual programming members 24 may remain in their previous hierarchy level, namely in a non-zoomed condition.

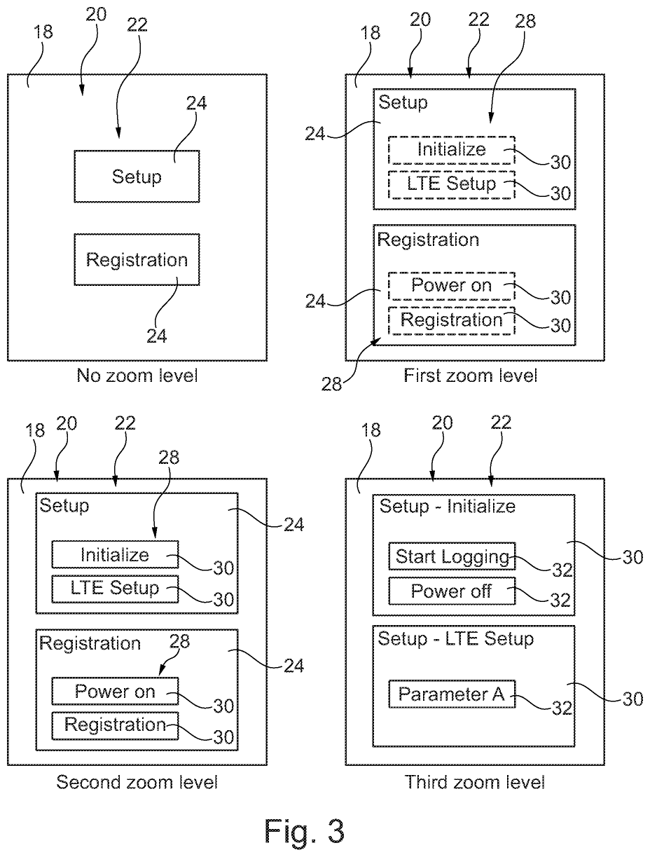

Although the sematic zoom function was shown for only one visual programming member 24, namely the third one, the sematic zoom function may also be applied to several visual programming members 24 simultaneously. This is shown in FIG. 3, which illustrates different zoom levels for the visual programming members 24.

In a zero zoom level, namely the starting hierarchy level, two visual programming members 24 are displayed on the display 18 via the graphical user interface 20, which are labelled with “Setup” and “Registration” in the shown embodiment.

In a first zoom level of the semantic zoom, subgroups 28 of both visual programming members 24 are indicated. In the respective zoom level, the visual programming sub-members 30 are already displayed, but they cannot be selected. Therefore, the visual programming sub-members 30 are illustrated by dashed lines.

In a second zoom level, the lower hierarchy level, namely the one assigned to the only the subgroup assigned to the subgroups 28, is active such that the visual programming sub-members 30 can be selected. The second zoom level was activated for both visual programming members 24 simultaneously such that both subgroups 28 are displayed at the same time.

In a third zoom level, the visual programming sub-members 30 assigned to the visual programming member 24 are zoomed in again such that visual programming sub-sub-members 32 are displayed on the graphical user interface 20. The visual programming sub-sub-members 32 relate to another hierarchy level that is lower than the one assigned to the visual programming sub-members 30 that relate to hierarchy level that is lower than the one assigned to the visual programming members 24.

However, the overall structure is still provided, as the respective relation is indicated by “Setup—Initialize” or rather “Setup—LTE Setup” appropriately.

In general, the user is enabled to easily move between an overview and details of the respective visual programming members 24 by using the semantic zoom function.

The nested structure, namely the respective subgroups 28, is only displayed on the display 18 via the graphical user interface 20 if the semantic zoom function for the respective visual programming member 24 has been activated previously. Therefore, the user has an overview of the entire structure at the beginning.

As shown, a seamless interaction within one editor window provided by the graphical user interface 20 is ensured wherein connections to the overall setup are kept. In some embodiments, the semantic zoom function relates to collapsing and expanding the respective visual programming member or rather its subgroups. Moreover, the semantic zoom function enables content exchange between the different hierarchy levels in a simple manner, for instance by drag and drop.

In addition to the semantic zoom function, the test system 10 may also comprise a regular graphical zoom function via which the whole content displayed is zoomed simultaneously. In contrast to the graphical zoom function, the semantic zoom function only provides a partial zoom of a content selected, namely a certain visual programming member 24 or a dedicated subgroup thereof.

The visual programming members 24 are assigned to a test sequence/test scenario, as they can be connected with each other in a desired manner in order to define the process of testing. Moreover, testing parameters or settings of certain groups may be defined in lower hierarchy levels.

By zooming into the respective visual programming members 24, the user is enabled to edit the settings appropriately. Accordingly, the visual programming members 24 are assigned to at least one of a test plan, a test sequence, a test function and a test command such that the respective zoom level may concern a test plan zoom, a test sequence zoom, a test function zoom and/or a test command zoom.

For instance, the test command zoom corresponds to opening a source code editor that is displayed on the display 18. Then, the user may edit the respective source code assigned to the test command. Accordingly, the semantic zoom provides the function of accessing and editing the source code.

It will be understood that the processor, one or more of the modules, such as the testing module, etc., described above may include, in some embodiments, logic for implementing the technologies and methodologies described herein. This logic of these components can be carried out in either hardware or software, or a combination of hardware and software. In an example, the functionality of one or more of these components could be implemented by special purpose hardware-based computer systems or circuits, etc., or combinations of special purpose hardware and computer instructions. In some embodiments, one or more of these components includes one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

In an embodiment, one or more of these components include a microprocessor and a memory storing logic modules and/or instructions. In an embodiment, one or more of these components include one or more ASICs having a plurality of predefined logic components. In an embodiment, one or more of these components include one or more FPGA having a plurality of programmable logic components. In an embodiment, one or more of these components includes combinations of circuits and computer program products having software or firmware instructions stored on one or more computer readable memories that work together to cause a device to perform one or more methodologies or technologies described herein. In an embodiment, one or more of these components includes hardware circuits (e.g., implementations in analog circuitry, implementations in digital circuitry, and the like, and combinations thereof) for carrying out the functionality described herein.

It will be appreciated that one or more aspects of the present disclosures can be carried out as methods implemented by a computer system. In this regard, one or more program elements are provided, which are configured and arranged when executed on a computer to carry out the technologies and methodologies set forth herein. In one embodiment, the one or more program elements may specifically be configured to perform one or more of the following steps or actions: generate a graphical user interface that is displayed on the display, wherein the graphical user interface generated provides a visual programming editor; provide a semantic zoom function for the graphical user interface, the semantic zoom function being configured to provide a semantic zooming of at least one of a first visual programming member and a second visual programming member such that a subgroup assigned to the respective visual programming member is displayed on the display via the graphical user interface; zoom the entire graphical user interface displayed on the display; select the respective visual programming member to be zoomed; assign the semantic zoom function to at least one of collapsing and expanding the respective visual programming member; etc.

The one or more program elements may be installed in memory, such as computer readable storage medium. The computer readable storage medium may be any one of the computing devices, modules, instruments, displays, etc., described elsewhere herein or another and separate computing device, modules, instruments, displays, etc., as may be desirable. The computer readable storage medium and the one or more program elements, which may comprise computer-readable program code portions embodied therein, may further be contained within a non-transitory computer program product.

As mentioned, various embodiments of the present disclosure may be implemented in various ways, including as non-transitory computer program products, computer readable instructions, etc. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, optical disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. Other non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM) of any rate, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The computer-readable media include cooperating or interconnected computer-readable media, which exist exclusively on a processing system or distributed among multiple interconnected processing systems that may be local to, or remote from, the processing system.

In some embodiments, one or more computer-readable storage media is provided containing computer readable instructions embodied thereon that, when executed by one or more computing devices (contained in or associated with the one or more components set forth above), cause the one or more computing devices to perform one or more steps or actions described herein. In other embodiments, one or more of these steps or actions can be implemented in digital and/or analog circuitry or the like.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A test system comprising a display and a processor, the processor being configured to generate a graphical user interface that is displayed on the display, the graphical user interface generated providing a visual programming editor, the visual programming editor comprising at least one of a first visual programming member and a second visual programming member, the processor being configured to provide a semantic zoom function for the graphical user interface, the semantic zoom function being configured to provide a semantic zooming of at least one of the first visual programming member and the second visual programming member such that a subgroup assigned to the respective zoomed visual programming member is displayed on the display via the graphical user interface, wherein the semantic zoom function provides a zooming of the respective visual programming member such that different hierarchy levels are displayed simultaneously within one window of the graphical user interface due to the semantic zoom function that is only applied to the respective visual programming member zoomed since the other visual programming member remains in its previous hierarchy level.

2. The test system according to claim 1, wherein the test system comprises a graphical zoom function, the graphical zoom function being configured to zoom the entire graphical user interface displayed on the display.

3. The test system according to claim 1, wherein the test system comprises an input interface to select the respective visual programming member to be zoomed.

4. The test system according to claim 3, wherein the input interface is provided by the display, the display being touch-sensitive.

5. The test system according to claim 1, wherein at least one of the first visual programming member and the second visual programming member is assigned to a test sequence.

6. The test system according to claim 1, wherein the visual programming editor comprises a plurality of visual programming members that are configured to be combined with each other in order to generate a test scenario.

7. The test system according to claim 1, wherein the plurality of visual programming members is assigned to at least one of a test plan, a test sequence, a test function and a test command.

8. The test system according to claim 1, wherein the semantic zoom function is assigned to at least one of collapsing and expanding the respective visual programming member.

9. The test system according to claim 1, wherein the semantic zoom function comprises at least one zoom level.

10. The test system according to claim 1, wherein the semantic zoom function comprises at least one of a test plan zoom, a test sequence zoom, a test function zoom and a test command zoom.

11. The test system according to claim 10, wherein at least one of the test plan zoom, the test sequence zoom, the test function zoom and the test command zoom has at least one zoom level.

12. The test system according to claim 11, wherein the zoom level assigned to the test command zoom corresponds to opening a source code editor that is displayed on the display.

13. The test system according to claim 1, wherein the subgroup assigned to the respective visual programming member corresponds to a nested structure.

14. The test system according to claim 13, wherein the nested structure is only displayed on the display via the graphical user interface if the semantic zoom function for the respective visual programming member has been activated.

15. The test system according to claim 1, wherein the semantic zooming provides a seamless interaction within one editor window displayed on the display such that established connections of subgroup members to the overall setup are still comprehensible for the user of the test system, as no pop-up window or separate window is generated for illustrating the members of the subgroup, and wherein the respective visual programming members is associated with more than two zoom levels.

16. The test system according to claim 1, wherein the semantic zooming provides a seamless interaction within one editor window displayed on the display, wherein the respective visual programming member comprises several visual programming sub-members which further comprise respective subgroups such that different hierarchy levels are provided, and wherein the semantic zoom function ensures that the closer the user gets due to a zoom level applied, the more content of the respective visual programming member is displayed on the display via the graphical user interface.

17. A test system comprising a display and a processor, the processor being configured to generate a graphical user interface that is displayed on the display, the graphical user interface generated providing a visual programming editor, the visual programming editor comprising at least one of a first visual programming member and a second visual programming member, the processor being configured to provide a semantic zoom function for the graphical user interface, the semantic zoom function being configured to provide a semantic zooming of at least one of the first visual programming member and the second visual programming member such that a subgroup assigned to the respective visual programming member zoomed is displayed on the display via the graphical user interface, wherein the semantic zooming provides a seamless interaction within one editor window displayed on the display such that established connections of subgroup members to the overall setup are still comprehensible for the user of the test system as no pop-up window or separate window is generated for illustrating the members of the subgroup, and wherein a content exchange between different hierarchy levels is ensured such that the user of the test system can easily move between an overview and intricate details by using the semantic zoom function.

18. The test system according to claim 17, wherein the respective visual programming member comprises several visual programming sub-members which further comprise respective subgroups such that different hierarchy levels are provided, and wherein the semantic zoom function ensures that the closer the user gets due to a zoom level applied, the more content of the respective visual programming member is displayed on the display via the graphical user interface.

19. A test system comprising a display and a processor, the processor being configured to generate a graphical user interface that is displayed on the display, the graphical user interface generated providing a visual programming editor, the visual programming editor comprising at least one of a first visual programming member and a second visual programming member, the processor being configured to provide a semantic zoom function for the graphical user interface, the semantic zoom function being configured to provide a semantic zooming of at least one of the first visual programming member and the second visual programming member such that a subgroup assigned to the respective visual programming member zoomed is displayed on the display via the graphical user interface, wherein the semantic zoom function relates to a mechanism to view an underlying meaning inside the respective visual programming member in order to illustrate substructures or rather nested structures of the respective visual programming member, wherein the semantic zoom function ensures that the closer the user gets due to a zoom level, the more content of the respective visual programming member is displayed on the display via the graphical user interface, and wherein, depending on the respective zoom level applied, only components of the subgroup assigned to the respective visual programming member are displayed on the graphical user interface.
